(19) United States
(12) Patent Application Publication
(10) Pub. No.: US 2024/0051331 A1
(43) Pub. Date: Feb. 15, 2024

(54) FRICTION BODY WITH ANISOTROPIC THERMAL CONDUCTIVITY

(71) Applicant: BIC Violex Single Member S.A., Anoixi (GR)

(72) Inventor: Nikolaos CHATZIGRIGORIOU, Anoixi (GR)

(73) Assignee: BIC Violex Single Member S.A., Anoixi (GR)

(21) Appl. No.: 18/547,276

(22) PCT Filed: Feb. 24, 2022
(86) PCT No.: PCT/EP2022/054717

§ 371 Date: Aug. 21, 2023

(30) Foreign Application Priority Data
Feb. 25, 2021 (EP) 21159200.1

(51) Int. Cl. B43L 19/00; B43K 29/00; B43L 19/04

(52) U.S. Cl. CPC B43L 19/0025; B43K 29/00; B43L 19/04

(57) ABSTRACT

The present disclosure relates to a friction body for discoloring handwriting written with a thermochromic ink with frictional heat, wherein the friction body comprises a surface portion configured to generate frictional heat when manually rubbed on a porous substrate and wherein 5 the friction body comprises a first thermal conductivity in a first direction substantially parallel to the surface plane which is greater than a second thermal conductivity in a second direction which is substantially perpendicular to the surface plane.

### CROSS REFERENCE TO RELATED APPLICATIONS

This is a National Stage Application under 35 U.S.C. § 371 of International Application No. PCT/EP2022/054717, filed Feb. 24, 2022, now published as WO 2022/180188 A1, which claims priority to European Patent Application No. 21159200.1, filed on Feb. 25, 2021, its content being incorporated herein by reference.

### TECHNICAL FIELD

The present disclosure relates to erasers for specifically erasing writing made with thermochromic ink and to writing instruments comprising such erasers.

### BACKGROUND OF THE DISCLOSURE

In recent years, writing instruments dispensing thermochromic inks have found widespread acceptance by the consumer. Thermochromic inks are inks which change or fade in color when heated above a certain temperature threshold. In a typical application, the user can erase a thermochromic handwriting by rubbing a friction body against the paper. The frictional heat generated by rubbing the friction body against a porous substrate, e.g. paper, heats the thermochromic handwriting above the ink's discoloration temperature and erases the handwriting.

Many materials have been suggested for friction bodies, including elastomers which are also used for erasers for conventional pencils. However, the relatively high discoloration temperatures may require stronger rubbing action, which, in turn, can erode, wrinkle, or otherwise damage the porous substrate, in particular paper. This is highly undesirable since it impedes or changes the appearance of a re-writing on rubbed areas. Thus, for a well-working friction body, it is necessary to balance the amount of generated frictional heat necessary for erasing the thermochromic ink against porous substrate damage caused by the rubbing action. Moreover, such elastomeric friction bodies, or more generally polymer-based friction bodies, lead to the formation of microplastic during the rubbing process. The created microplastic can be expected to be detrimental to the environment, the general population, and the user itself.

The present disclosure aims at improving some or all of the aforementioned issues in the prior art.

### Summary of the Present Disclosure

To discolor thermochromic ink heat is required at the interface of the friction body and the porous substrate. The present disclosure is i.a. based on the recognition that it is generally advantageous to prevent heat dissipation from the surface plane of the friction body towards its core. Moreover, it would be advantageous to prevent local heat peaks on the friction body during the rubbing process, as these local heat peaks may lead to localized deterioration of the porous substrate. Such local heat peaks may form especially on the surface of friction bodies with low thermal conductivity in the surface plane.

In a first aspect, the present disclosure relates to a friction body for discoloring handwriting written with a thermochromic ink with frictional heat. The friction body may comprise a surface portion configured to generate frictional heat when manually rubbed on a porous substrate. The porous substrate may in particular be a paper substrate. The friction body may have a first thermal conductivity in a first direction, the first direction being substantially parallel to the surface plane. Further, the friction body may have a second thermal conductivity in a second direction, the second direction being substantially perpendicular to the surface plane. The first thermal conductivity may be greater than the thermal conductivity in the second direction.

In some embodiments the first thermal conductivity may be at least about 1.5 times greater, more specifically 1.8 times greater, even more specifically 2 times greater, than the second thermal conductivity.

In some embodiments the second thermal conductivity may be less than about 0.30 W/(m·K), more specifically less than about 0.15 W/(m·K), more specifically less than about 0.05 (W/m·K).

In some embodiments the friction body may comprise a third thermal conductivity in a third direction which is substantially perpendicular to the first direction and parallel to the surface plane is substantially the same as the second thermal conductivity.

In some embodiments the friction body may comprise a multiplicity of longitudinal structures which are arranged substantially parallel to each other, wherein each of the longitudinal structures has a thermal conductivity which is greater in a longitudinal direction than in a transversal direction.

In some embodiments the friction body may comprise a multiplicity of tubular lumina which are arranged substantially parallel to each other.

In some embodiments the tubular lumina may be filled with a gas.

In some embodiments the tubular lumina may be comprised of cellulose.

In some embodiments the tubular lumina may have an inner diameter of between about 50 μm and about 500 μm, more specifically about 75 μm and about 300 μm, and more specifically between about 50 μm and about 200 μm.

In some embodiment the walls of the tubular lumina may have a wall thickness of between about 10 μm and about 100 μm, more specifically about 20 μm and about 75 μm, and in particular between about 30 μm and about 100 μm.

In some embodiments the tubular lumina may comprise walls comprising nano-sized tubular structures.

In some embodiments the tubular lumina may be formed by a piece of natural wood that has been chemically treated to remove at least a part of the lignin from the natural wood while substantially preserving the structure of cellulose-based tubular lumina of the natural wood.

In some embodiments the surface plane may be configured to heat to a surface temperature of between about 40° C. to about 80° C. when pressed onto a 45 g/m² paper made of 100% chemical pulp and having a brightness of about 83% with a load of about 500 g per about 3 mm² to about 8 mm², in particular about 4 mm² to about 5 mm², contact area and pulled across the paper with a constant pull rate of about 10 to about 200 mm/min.

In some embodiments the friction body may be comprised of a plant-based material having a density of less than about 0.30 g/cm³, more specifically less than about 0.25 g/cm³, and in particular less than about 0.20 g/cm³.

In some embodiments the friction body may be comprised within a writing instrument or a cap for capping the tip of a writing instrument.

### DETAILED DESCRIPTION OF THE PRESENT DISCLOSURE

Hereinafter, a detailed description will be given of the present disclosure. The terms or words used in the description and the claims of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

The inventor of the present disclosure has surprisingly found, through assiduous study, that the thermochromic image or handwriting may be reliably thermally discolored by frictional heat of the friction body while at the same time reducing excessive local heat peaks when providing the friction body with anisotropic thermal conductivity, more specifically an anisotropy generally oriented in perpendicular direction to the rubbing surface.

Accordingly, in a first aspect, the present disclosure relates to a friction body for discoloring handwriting written with a thermochromic ink with frictional heat. The friction body may comprise a surface portion configured to generate frictional heat when manually rubbed on a porous substrate. The porous substrate may be in particular a paper substrate. The friction body may have a first thermal conductivity in a first direction, the first direction being substantially parallel to the surface plane. Further, the friction body may have a second thermal conductivity in a second direction, the second direction being substantially perpendicular to the surface plane. The first thermal conductivity may be greater than the thermal conductivity in the second direction.

In some embodiments, the friction body may comprise a surface layer, wherein the surface layer extends up to 5 mm, more specifically up to 3 mm and in particular up to 2 mm into the second direction, wherein the surface layer has the first thermal conductivity in the first direction and the surface layer has the second thermal conductivity in the second direction.

The term “body” within this disclosure may refer to its common meaning in the art. Additionally or alternatively, the term “body” may refer to a solid structure. In some embodiments, the body may comprise voids, e.g. pores, wherein the voids have a maximum diameter of 1 mm, more specifically 500 μm and in particular 200 μm.

In some embodiments the first thermal conductivity may be at least about 1.5 times greater, more specifically 1.8 times greater, even more specifically about 2 times greater, than the second thermal conductivity. The greater the difference in thermal conductivities along the axis, the greater the heat distribution in the surface plane in comparison to the heat dissipation into the bulk of the material. A high heat dissipation into the friction body may be undesirable, as it increases the overall required heat energy (and, thus, at least for careless users, also the rubbing force) for erasing a thermochromic ink. A higher heat distribution within the surface plane may be desirable for a more uniform temperature in the surface plane, which may prevent local heat peaks, which otherwise could lead to localized deterioration of the porous substrate.

The second thermal conductivity may be less than about 0.30 W/(m·K), more specifically less than about 0.15 W/(m·K), and in particular less than about 0.05 or 0.050 W/(m·K). In some embodiments, it may be particularly advantageous that the second thermal conductivity is less than about 0.045 W/(m·K); specifically within a range of between about 0.015 W/(m·K) and about 0.045 W/(m X); more specifically between about 0.025 W/(m·K) and about 0.04 or 0.040 W/(m·K), and in particular between about 0.03 W/(m·K) and about 0.04 W/(m·K) or between about 0.030 W/(m·K) and about 0.040 W/(m·K).

The method of measuring the first and second (or other) thermal conductivity is not particularly limited as long as they are measured by the same method. For instance, in some embodiments, the thermal conductivity may be measured as disclosed in U.S. Pat. No. 9,592,702 B2, the disclosure of the measuring method being incorporated herein by reference thereto.

Additionally or alternatively, the thermal conductivity may be measured by use of a Trident manufactured by the company C-Therm and a Flex-TPS Sensor. The measurement may be performed according to ISO 22007-2:2015. The material may be first measured in a first direction and then in a second direction perpendicular to the first direction.

In some embodiments the friction body may comprise a third thermal conductivity in a third direction which is substantially perpendicular to the first direction and parallel to the surface plane and is substantially the same as the second thermal conductivity.

In some embodiments the friction body may comprise a multiplicity of longitudinal structures. The longitudinal structures may be tubular lumina, for instance tubular lumina as can be found in natural wood. Examples of longitudinal structures and/or tubular lumina include wooden fibers or nano- or micro-sized cellulose-based tubings. However, in some embodiments, the longitudinal structures and/or tubular lumina may also be based on other plant material or be of synthetic nature.

In some embodiments, the multiplicity of longitudinal structures may be arranged substantially parallel or parallel to each other, wherein each of the longitudinal structures has a thermal conductivity which is greater in a longitudinal direction than in a transversal direction.

In view of the fact that longitudinal structures may e.g. be wooden fibers or nano- or micro-sized tubings of other plant-based origin, it should be understood that it is not necessary that each longitudinal structure is exactly parallel to every other longitudinal structure as long as the aforementioned anisotropy in thermal conductivity of the frictional body is preserved. Rather, in some embodiments, it may be sufficient that the longitudinal structures are generally oriented in the same direction. In some embodiments, it may be sufficient that a majority of the longitudinal structures, for instance about 80% or more, specifically about 90% or more, and in particular about 96% or more, are oriented within a deviation of about +/−10° or less, specifically about +/−7° or less, and in particular about +/−5° or less, in the same direction.

It should also be understood that the orientation of the multiplicity of longitudinal structures or tubular lumina does not need to be perfectly matched to the aforementioned anisotropy of the first and second thermal conductivity. Rather, the anisotropy will also be (at least partially) retained in cases where the general orientation of the multiplicity of longitudinal structures or tubular lumina is (slightly to moderately) deviating from the surface plane serving as reference plane for defining the first and second thermal conductivity. Accordingly, in some embodiments, the tubular lumina may not be arranged substantially parallel to the surface plane. In some embodiments the angle between (general) orientation of the multiplicity of longitudinal structures or the (general) orientation of the multiplicity of tubular lumina and the surface plane may be between about 0° and about 45°, more specifically between about 5° and about 30°, and in particular between about 10° to about 20°.

In some embodiments, the friction body may comprise a multiplicity of tubular lumina which are arranged substantially parallel to each other. In some embodiments, the tubular lumina may be filled with a gas. In some embodiments, within a friction body comprising of such tubular lumina, and wherein the tubular lumina are not filled with another material, the tubular lumina may be filled with the ambient atmosphere. Moreover, in some embodiment, the pores or intercostal space between the tubular lumina may also be filled with gas, in particular ambient atmosphere. This may further facilitate the anisotropy of the first and second thermal conductivity. In other embodiments, the pores or intercostal space between the tubular lumina may be filled partially or completely with a further material, for instance a material such as a filler, a binder, or an adhesive. While such a material may sacrifice a part of the anisotropy of the first and second thermal conductivity, it may facilitate the structural integrity of the friction body and/or reduce loss of material during the rubbing action.

As mentioned above, plant-based materials may comprise tubular lumina. Furthermore, plant-based materials may comprise cellulose. These tubular lumina may comprise walls and these walls may be comprised of cellulose. Accordingly, in some embodiments, it may be advantageous that the tubular lumina comprises cellulose since such tubular lumina are relatively easy and cost-efficient to obtain.

In some embodiments the tubular lumina may have an inner diameter of between about 50 μm and about 500 μm, more specifically about 75 μm and about 300 μm, and in particular between about 50 μm and about 200 μm.

In some embodiment the walls of the tubular lumina may have a wall thickness of between about 10 μm and about 100 μm, more specifically about 20 μm and about 75 μm, and in particular between about 30 μm and about 100 μm.

In some embodiments the tubular lumina may comprise walls comprising nano-sized tubular structures. These nano-sized tubular structures may also be filled with gas. As used herein, the term “nano-sized tubular structures” in particular refers to very small tubular structures having an average diameter on the nanoscale.

In some embodiments the tubular lumina may be formed by a piece of natural wood that has been chemically treated to remove at least a part of the lignin from the natural wood while substantially preserving the structure of cellulose-based tubular lumina of the natural wood, in particular delignified wood.

Natural wood is a composite of cellulose nanofibers embedded in a matrix of lignin (often about 20 wt.-% to about 35 wt.-%) and cellulose (often about 40 wt.-% to about 50 wt.-%) and hemicellulose (i.e. polysaccharides other than cellulose). Natural wood also has a three-dimensional porous structure with multiple channels, including vessels and fibril tracheid lumina (e.g., tubular lumina of about 20-80 μm in cross-sectional dimension) extending in a direction of wood growth. Cell walls in the natural wood are mainly composed of the cellulose, hemicellulose, and lignin, with the three components intertwining with each other to form a strong and rigid wall structure. In some embodiments, the friction body may be made of wood, wherein substantially all of the lignin in the natural wood is removed to form a piece of delignified wood. As used herein “delignified” or “delignification” in particular refers to removing substantially all of the lignin from the natural wood, and “removing substantially all of the lignin” means that at least about 90 wt.-% of the lignin that naturally exists in the wood has been removed. In some embodiments, the weight percentage (wt.-%) of lignin may be reduced from over 20 wt.-% in natural wood to less than 5 wt.-% in the delignified wood, and more specifically less than 1 wt.-% (e.g., <0.6 wt.-%). Concurrent with the lignin removal, some or substantially all of the hemicellulose may also be removed.

An exemplary process to prepare delignified wood is described in WO 2019/055789 A1, the content of which are incorporated by reference herein.

The resulting plant-based material delignified wood is more porous and less rigid than the original natural wood. The resulting delignified wood material is lightweight yet strong due to the effective bonding between the aligned cellulose nanofibrils.

In some embodiments, the friction body may comprise a plant-based material, in particular delignified wood. The term “plant-based”, as used here-before and elsewhere throughout the specification, is not particularly limited and in particular includes materials from plant origin, materials obtained by processing plants, and materials of fungal origin.

In some embodiments, the friction body or the surface portion of the friction body may comprise a plant-based material having a first thermal conductivity and domains arranged within the plant-based material having a second thermal conductivity which is lower than the first thermal conductivity. In some embodiments such a friction body may comprise delignified wood.

A further advantage of a friction body made from plant-based materials, for example delignified wood, is that any particles created when using the friction body would be biodegradable. Hence, the use of plant-based materials for friction bodies may prevent, unlike other typically used materials, the formation of persisting microplastic during the discoloration of thermochromic ink.

The plant-based material, in particular delignified wood, has a first (higher) thermal conductivity and gas-filled pores form the domains arranged within the plant-based material having a second (lower) thermal conductivity. The plant-based material may be comprised of a multiplicity of tubular lumina, which are substantially parallel to each other. The tubular lumina accordingly would have a greater thermal conductivity along its longitudinal direction, than along its transversal direction which includes the gas filled pores.

In some embodiments, in delignified wood these longitudinal lumina could be comprised of cellulose.

In some embodiments, the friction body may comprise a plant-based material, in particular delignified wood. These materials are more environmentally friendly than friction bodies made of synthetic materials.

Accordingly, in some embodiments, the present disclosure relates to a friction body for discoloring handwriting written with a thermochromic ink with frictional heat, wherein the friction body comprises a surface portion comprising plant-based material, in particular delignified wood. The delignified wood exhibits unique thermal properties, in particular, a very low thermal conductivity and anisotropic thermal conductivity, that enable the delignified wood material to function as an excellent thermal insulator. Conventional thermal insulators are typically isotropic, which may hinder effective thermal management. In contrast, the anisotropy of the thermal conductivity in the delignified wood materials can provide efficient thermal dissipation along the axial direction, thereby preventing local heat peaks on the side of the delignified wood used for rubbing while improving the thermal insulation towards the core of the delignified wood body, thereby preserving the generated heat at the surface plane. The preservation of heat at the surface plane, decreases the required effort for heating the surface to a temperature suitable for thermal discoloration, as less heat dissipation needs to be compensated by stronger or faster rubbing.

The friction body, in particular a friction body made of delignified wood may have a density of less than about 0.30 g/cm³, more specifically less than about 0.25 g/cm³, and in particular less than about 0.20 g/cm³.

In some embodiments, the surface portion may be configured to heat to a surface temperature of between about 40° C. to about 80° C. during the rubbing action. In this context, the term “surface temperature” is intended to mean the temperature at the interface between the surface portion of the friction body and the surface of the porous substrate. As such, determining the surface temperature is not particularly limited and can be measured on either the surface portion of the friction body or the surface portion of the porous substrate. A surface temperature of below about 40° C. may be too low to reliably discolor the thermochromic ink whereas a surface temperature of above about 80° C. may damage the paper and/or feel uncomfortable to the user. Configuring the surface portion to heat to the aforementioned temperatures may be achieved by adjusting the surface roughness of the surface portion and/or by selecting materials having inherently high friction. Suitable materials can also be identified by pressing a sample onto standardized paper and measuring the generated surface heat when moving the sample under load under standardized conditions. Accordingly, in some embodiments, particularly advantageous materials provide a surface portion which is configured to heat to a surface temperature of between about 40° C. to about 80° C., specifically between about 45° C. and about 70° C., and in particular between about 50° C. and about 70° C., when rubbed onto a 45 g/m² paper made of 100% chemical pulp and having a brightness of about 83% with a load of about 500 g per about 3 mm² to about 8 mm², in particular about 4 mm² to about 5 mm², contact area and pulled across the paper with a constant pull rate of about 50 to about 500 mm/s, more specifically of about 50 to about 200 mm/s, even more specifically between about 70 and about 150 mm/s, and in particular between about 80 and about 120 mm/s. The aforementioned load, contact areas and pull rates were found to ideally represent the range of rubbing actions of typical users and, thus, allows to effectively and effortlessly determine materials having the required thermal conductivity and a suitable generation of frictional heat. In some embodiments, it may be advantageous that the surface temperature refers to the temperature measured on the surface of the porous substrate.

Further, potentially suitable materials may be identified by theoretical considerations prior to performing rub tests according to the prior description. In some embodiments, suitable materials may have an anisotropic material composition, in particular suitable materials may comprise a continuous material structure in the first direction and a discontinuous material structure in the second direction, especially wherein gaps in the discontinuous material structure are filled by a gas. Examples for further materials comprising a first thermal conductivity in a first direction substantially parallel to the surface plane which is greater than a second thermal conductivity in a second direction which is substantially perpendicular to the first direction, may be for example hollow polymer tubes or a polymer comprising a grid-like structure, wherein the grid gaps are filled with a gas. The thermal conductivity of these anisotropic materials may then be measured from different directions perpendicular to one another to identify suitable materials, for example with a Trident manufactured by the company C-Therm and a Flex-TPS Sensor, according to ISO 22007-2:2015.

Additional materials can be added to the friction body, in particular a friction body made of delignified wood. The added materials can add functionality not otherwise available within the material, for example, by improving mechanical properties or acting as a binder for dust particles, while enjoying the improved anisotropic thermal and/or mechanical performance offered by the anisotropic material of the friction body, in particular delignified wood.

In some embodiments the friction body may comprise one or more anti-delamination elements. This anti-delamination element is configured to provide stabilization to the friction body, in particular stabilization against mechanical forces, in particular against shear forces. The anti-delamination element may be in the form of a structural element, or alternatively in the form of an additional material compounded into the whole friction body or parts thereof.

The anti-delamination element provides mechanical stabilization to an anisotropic material comprising tubular lumina, to prevent distortion and breaking of tubular lumina and/or detachment of tubular lumina from one another, in particular slipping.

The anti-delamination element as a structural element may provide stabilization against mechanical forces, in particular against shear forces, by providing a supporting surface. In some embodiments, in particular wherein the friction body comprises tubular lumina, the supporting surface may allow the tubular lumina to transfer mechanical forces onto the structural element via the supporting surface, thereby locking the tubular lumina in place, preventing distortion, breaking and/or slipping of the tubular lumina.

In some embodiments, the anti-delamination element may be a stabilization ring attached around fringe area(s) of the friction body. The stabilization ring may or may not be round, square, elliptic and/or comprise one or more corners and may or may not be a circumferentially closed structure.

The anti-delamination element may be part of a writing instrument or an independent sheathing. The anti-delamination element may be slidable relative to the friction body in the second direction, to adjust how far the friction body protrudes beyond the anti-delamination element.

The anti-delamination element in the form of an additional material compounded into or onto the friction body may provide stabilization against mechanical forces, in particular against shear forces, by increasing the internal cohesion of the material. In particular for isotropic materials comprising tubular lumina, the anti-delamination element may provide stabilization against mechanical forces by increasing the cohesion between the tubular lumina. The increased cohesion between the tubular lumina increases the threshold of mechanical forces the friction body can be exposed to, before breaking, distorting and/or slipping of the tubular lumina occurs. The additional material may comprise in particular an adhesive, a thermoplastic polymer, a resin, a synthetic or natural elastomer, and in particular a thermoplastic elastomer.

In some embodiments the friction body may comprise a further binder material, to prevent particles which may be formed during the rubbing action, to become airborne. These particles may be in particular abrasion, in particular particles comprising cellulose. The binder material may be characterized by a high degree of adhesion to the particles, hereby binding to particles formed during the rubbing action. The mechanism of adhesion may be mechanical, chemical, dispersive, electrostatic and/or diffusive.

In some embodiments, the friction body, in particular delignified wood, may be compounded with the anti-delamination element or binder material only in certain areas. The specific configuration of the compounded areas is not particular limited and may in particular be selected from the following configurations, wherein the friction body is only compounded:
in the fringe area(s), which may be the outer rim(s) of the friction body oriented perpendicular to the surface plane;
in the center, in particular in a circular or rectangular shape;
in a plurality of isolated dots;
in a cross-shaped form;
in alternating layers, more specifically along the third direction.

In some embodiments the anti-delamination element and the binder material may be the same material.

In some embodiments, the friction body may be composed of a single material, i.e. the core underneath the friction body's surface portion may be made of the same material as the surface portion itself. Alternatively, the surface portion may be made of a different material than the core material, for instance to modulate the stiffness and compression behavior of the friction body. Additionally or alternatively, the friction body may comprise two or more surface portions composed of different materials, for instance a surface portion for more aggressive rubbing action (e.g. having a higher coefficient of friction) and a surface portion for less aggressive rubbing action (e.g. having a lower coefficient of friction).

In some embodiments the friction body may be comprised within a sheathing within a writing instrument or a cap for capping the tip of a writing instrument.

In some embodiments, there may be provided a writing instrument comprising a friction body. The writing instrument may comprise a writing tip and a storage compartment. The storage compartment may comprise a thermochromic ink. The storage compartment may be in fluid communication with the writing tip. The friction body may be according to any of the aforementioned embodiments.

In some embodiments, the thermochromic ink is configured to change its color or discolor when heated to a temperature of between about 40° C. to about 80° C., specifically between about 45° C. and about 70°, and in particular between about 50° C. and about 65° C.

In some embodiments the friction body may be comprised within a sheathing comprised within a shaft, to be used independently of a writing instrument.

In some embodiments the sheathing may comprise a movable basis, the movable basis being movable in the second direction. The friction body may be attached to this movable basis, to enable sliding of the friction body in or out of the sheathing in the second direction. This may be preferable to adjust how far the friction body protrudes from the sheathing, to protect the friction body from mechanical forces, especially from shear forces.

In some embodiments the friction body may be attached to a writing instrument or independent sheathing, by an edging. In some embodiments the edging may comprise the anti-delamination element.

In some embodiments the friction body may be attached to a writing instrument or independent sheathing by being placed on a pin or hook.

In some embodiments the friction body may be attached to a base of a writing instrument or independent sheathing by an adhesive, wherein the adhesive may comprise in particular a glue, a polymer, a resin or a wax.

In some embodiments the friction body may be attached to a base of a writing instrument or independent sheathing by an adhesive such as a hook and loop fastener, e.g. a Velcro pad.

In some embodiments the friction body may be shaped from a larger block of material. The shaping may comprise subtractive techniques, for example cutting, turning, milling, chipping, slicing, boring, or grinding.

1. A friction body for discoloring thermochromic handwriting written with a thermochromic ink with frictional heat, wherein the friction body comprises a surface plane configured to generate frictional heat when manually rubbed on a porous substrate and wherein the friction body comprises a first thermal conductivity in a first direction substantially parallel to the surface plane which is greater than a second thermal conductivity in a second direction which is substantially perpendicular to the surface plane.

2-15. (canceled)

16. The friction body according to claim 1, wherein the porous substrate is a paper substrate.

17. The friction body according to claim 1, wherein the first thermal conductivity is at least about 1.5 times greater than the second thermal conductivity.

18. The friction body according to claim 1, wherein the first thermal conductivity is at least 1.8 times greater than the second thermal conductivity.

19. The friction body according to claim 1, wherein the second thermal conductivity is less than about 0.30 W/(m·K).

20. The friction body according to claim 1, wherein the second thermal conductivity is less than about 0.15 W/(m·K).

21. The friction body according to claim 1, wherein the second thermal conductivity is less than about 0.05 W/(m·K).

22. The friction body according to claim 1, wherein a third thermal conductivity in a third direction which is substantially perpendicular to the first direction and parallel to the surface plane is substantially the same as the second thermal conductivity.

23. The friction body according to claim 1, wherein the friction body comprises a multiplicity of longitudinal structures which are arranged substantially parallel to each other, wherein each of the longitudinal structures has a thermal conductivity which is greater in a longitudinal direction than in a transversal direction.

24. The friction body according to claim 1, wherein the friction body comprises a multiplicity of tubular lumina which are arranged substantially parallel to each other.

25. The friction body according to claim 25, wherein the tubular lumina are filled with gas.

26. The friction body according to claim 25, wherein the tubular lumina comprise cellulose.

27. The friction body according to claim 25, wherein the tubular lumina have an inner diameter of between about 50 μm and about 500 μm.

28. The friction body according to claim 25, wherein the tubular lumina have a wall thickness of between about 10 μm and about 100 μm.

29. The friction body according to claim 25, wherein the tubular lumina comprise walls comprise nano-sized tubular structures.

30. The friction body according to claim 25, wherein the tubular lumina are formed by a piece of natural wood that has been chemically treated to remove at least a part of the lignin from the natural wood while substantially preserving the structure of cellulose-based tubular lumina of the natural wood.

31. The friction body according to claim 1, wherein surface plane is configured to heat to a surface temperature of between about 40° C. to about 80° C. when pressed onto a 45 g/m² paper made of 100% chemical pulp and having a brightness of about 83% with a load of about 500 g per about 3 mm² to about 8 mm² contact area and pulled across the paper with a constant pull rate of about 10 to about 200 mm/min.

32. The friction body of claim 1, wherein the friction body comprises a plant-based material having a density of less than about 0.30 g/cm³.

33. The friction body of claim 1, wherein the friction body comprises a plant-based material having a density of less than about 0.25 g/cm³.

34. A writing instrument or a cap for capping the tip of a writing instrument comprising the friction body of claim 1.
